(19) United States
(12) Patent Application Publication
(10) Pub. No.: US 2012/0069864 A1
(43) Pub. Date: Mar. 22, 2012

(54) DIODE PUMPED SOLID-STATE LASER WITH IMPROVED PUMP LIGHT ABSORPTION

(75) Inventors: Ulrich Weichmann, Aachen (DE); Uwe Mackens, Aachen (DE)

(73) Assignee: KONINKLIJKE PHILIPS ELECTRONICS N.V., Eindhoven (NL)

(21) Appl. No.: 13/321,898

(22) PCT Filed: May 21, 2010
(86) PCT No.: PCT/IB2010/052276

§ 371 Date: Nov. 22, 2011

(30) Foreign Application Priority Data
May 28, 2009 (EP) 09161402.4

(51) Int. Cl. H01S 3/0941

(52) U.S. Cl. 372/75

(57) ABSTRACT

For a diode pumped solid-state laser, measures to improve the pump light absorption in anisotropic crystals are proposed. The proposed measures reduce the dependency of the pump light absorption on the diode current and the diode temperature as well as on the detuning of the pump diode from the absorption line. These measures include sending the pump radiation twice through the crystal, placement of the laser crystal in an orientation that does not exhibit the optimum absorption and the use of a retarder.

### FIELD OF THE INVENTION

The invention generally concerns the field of solid state lasers and more specifically to diode pumped solid state lasers.

### BACKGROUND OF THE INVENTION

Many solid-state lasers are realized on narrow emission-lines that correspond to 4f-4f-transitions in rare-earth ions. Most of these systems are also characterized by a narrow and weak absorption band that corresponds to 4f-4f-transitions in the rare-earth ions as well. Efficient diode-pumping of these materials is achieved by a good match of the pump diode emission wavelength to the absorption line of the ion, which can be accomplished by properly selected pump diodes and a good tuning and stabilization of the diode temperature.

Diode pumped solid-state lasers (DPSSL) are nowadays mostly Nd:YAG or Nd:YVO₄-lasers which emit at infrared wavelengths and are used for e.g. medical applications or material processing applications. These applications require a low to mid-sized volume of laser sources and allow for a quite high price level. Manual to semi-automated production of these lasers is therefore quite common. This, however, renders the aforementioned laser unsuitable for large volume or mass production as required for applications such as future generations of laser projectors.

This might change if the recently developed blue diode pumped solid-state lasers (bDPSSL), which emit in the visible wavelength range could be used as the light source in projection applications.

Typical bDPSSLs are based on LiYF₄:Pr, hereinafter referred to as Pr:YLF, or Pr:LiLuF₄ as the laser medium. These crystals are characterized by an anisotropic crystal structure, narrow absorption lines and absorption coefficients in the order of a few cm⁻¹.

Due to the anisotropic structure of the crystal, a good alignment of the crystal orientation with the c-axis parallel to the laser polarization is required for best pump light absorption. The emission wavelength of the pump diode has to be selected to fall within a wavelength range of +/−1 nm. Currently, pump diodes are offered with emission wavelengths between 440 nm and 455 nm.

Crystals used in typical bDPSSL setups are accordingly only a few mm up to about lcm in length. A shorter crystal would be preferable since this generally facilitates mode matching of the pump beam with the laser mode. Mode matching becomes more complicated for high power pump diodes, since an increase in pump power goes along with a deterioration of the beam quality or the M²-factor, respectively.

### OBJECT AND SUMMARY OF THE INVENTION

It is therefore an object of the invention, to provide a diode pumped solid state laser which allows for larger tolerances in the optical alignment.

In this invention, measures to improve the pump light absorption in anisotropic crystals are proposed, that reduce the dependency of the pump light absorption on the diode current, the diode temperature as well as on the detuning of the pump diode from the absorption line.

These measures include sending the pump radiation twice through the crystal, the use of longer crystals, placement of the laser crystal in an orientation that does not exhibit the optimum absorption and the use of a retarder (also referred to as a wave-plate), such as a quarter-wave-plate inside the laser cavity.

Each of these measures, in particular a combination of some or all of these measures will increase the tolerances in the setup of diode pumped solid-state lasers and therefore reduce the production cost especially in large volume production.

Accordingly a diode pumped solid state laser device is provided, comprising

a pump laser diode and

a laser crystal,

wherein the laser crystal forming at least a part of a solid state laser which emits laser light at a wavelength different from the wavelength of the laser light emitted from the pump laser diode, and wherein

the solid state laser is optically pumped by the pump laser diode. The pump laser diode is arranged to inject its pump laser light in longitudinal direction into the laser crystal.

The diode pumped solid state laser device further comprises at least one of the following means:

an output coupler which reflects back the fraction of said pump laser light longitudinally transmitted through said laser crystal,

an anisotropic laser crystal having two different absorption coefficients for pump light polarized along a first direction transversally to the longitudinal direction of the solid state laser and a second direction vertically to said first direction, wherein said anisotropic laser crystal and said pump laser diode are mutually oriented so that the polarization of said pump laser light has a component both along said first and said second direction,

a retarder or wave-plate, respectively, which converts the pump light from linearly polarized light into elliptically or, ideally, into circularly polarized light.

Suitably, the retarder is arranged within the cavity of the solid state laser or in front of the light entry side of the laser cavity, where the pump light is injected.

The reflection of the pump light back into the cavity by means of a suitable output coupler increases the pump light absorption. Furthermore, the intensity distribution of the absorbed pump light is homogenized. As the absorption is increased, shorter laser crystals may be used, thereby advantageously facilitating mode matching. Preferably, the crystal length is chosen so that a fraction of at least 5 percent, preferably at least 10 percent, particularly preferable at least 20 percent of the pump laser radiation initially injected into the crystal is transmitted through the crystal and at least partially reflected back by the output coupler.

The longitudinal direction of the solid state laser is defined as the direction along which the laser beam of the solid state laser is emitted and therefore coincides with the optical axis of the solid state laser.

The invention is preferably applied to bDPSSLs. Accordingly, in this case the pump laser diode is a blue emitting laser diode. The invention allows for relaxed production tolerances of bDPSSLs, thereby reducing the production costs so that an inventive bDPSSL can be used as a light source in consumer products such as video projectors.

Suitably, pump laser diodes emitting at a wavelength within the range from 435 to 455 nanometers may be employed.

To inject the pump light in longitudinal direction into the cavity of the solid state laser, the solid state laser preferably comprises a wavelength selective mirror terminating its laser cavity at the opposite end of the output coupler. The wavelength selective mirror is transmissive for the pump laser light and reflective for the laser light of the solid state laser.

Similarly, to avoid pump laser light transmitted through the output coupler, it is further advantageous to employ a wavelength selective mirror on the output side of the laser crystal, whereby the wavelength selective mirror is highly reflective for the pump laser light but at least partly transmissive for the laser light of the solid state laser. In particular, the output coupler itself may be designed as a wavelength selective mirror which is semi-transparent for the laser light of the solid state laser, but highly reflective for the pump laser light. For example, the transmission for the solid state laser light may be within the range of 1% to 20% and the transmission for the pump laser light may be less than 0.5%.

Further, preferred materials for the laser crystal are Pr:YLF, Pr:LiLuF₄, Pr:LiGdF₄, Pr:BaY₂F₈, and Pr:KYF₄ . These crystals are anisotropic and capable to emit laser light at a variety of different colors including the green wavelength range and are thus very suitable to provide one or more color components of a color laser projector.

Usually, it is preferred to choose an orientation of the polarization plane parallel to the first direction of polarization where the laser crystal has its maximum absorption for the pump laser light. However, according to an embodiment of the invention, the system is out of tune from the orientation with the maximum conversion efficiency as the pump laser polarization is not oriented along the direction of maximum absorption but has a component along the second direction having a lower absorption. Nevertheless, this measure has been proven very advantageous to stabilize the intensity of the solid state laser, as is elucidated in more detail below. In particular, the c-axis of the laser may be oriented transversally to the longitudinal direction of the solid state laser, wherein the laser crystal is oriented with respect to the pump laser diode so that the plane of polarization of the pump laser light and the c-axis of said crystal include an angle. For example, the maximum absorption in Pr:YLF-crystals occurs with the plane of polarization being parallel to the c-axis. Preferred angles are between 30° and 60°, particularly preferably between 35° and 55°. Due to the optical anisotropy including the different absorption coefficients, pump light transmitted through the crystal and reflected back to the pump laser diode changes its polarization state so that this light has at least a component polarized perpendicular to the light emitted from the diode. Thus, self-mixing effects in the laser diode are reduced since perpendicularly polarized beams do not interfere with each other.

It is also possible to alter the polarization state of the light by means of an additional element. In this regard, as mentioned above, it is proposed to use a retarder or wave-plate. Preferably, a quarter wave-plate is employed to produce circularly polarized light. Further, to obtain a high degree of circular polarization, the optical axis of the retarder and the polarization plane of the pump laser light preferably include an angle of between 35 and 55°.

### BRIEF DESCRIPTION OF THE DRAWINGS

FIG. 1 shows an embodiment of a solid state laser device according to the invention.

FIG. 2 shows a diagram of the absorption coefficient of Pr:YLF as a function of the wavelength for two orientations of the polarization plane with respect to the c-axis of the Pr:YLF crystal.

FIG. 3 shows graphs of the transmission as a function of the path length through the laser crystal for different laser diode currents and angles of 0° and 45° between polarization vector and c-axis of the laser crystal.

FIG. 4 shows graphs of the transmission as a function of the path length through the laser crystal for different temperatures of the pump laser diode and angles of 0° and 45° between polarization vector and c-axis of the laser crystal.

FIG. 5 shows a further embodiment of a solid state laser device according to the invention with a quarter wave plate arranged in the cavity of the solid state laser.

FIG. 6 shows a variant of FIG. 5 with the quarter wave plate placed between the pump laser diode and the solid state laser cavity.

### DETAILED DESCRIPTION OF EMBODIMENTS

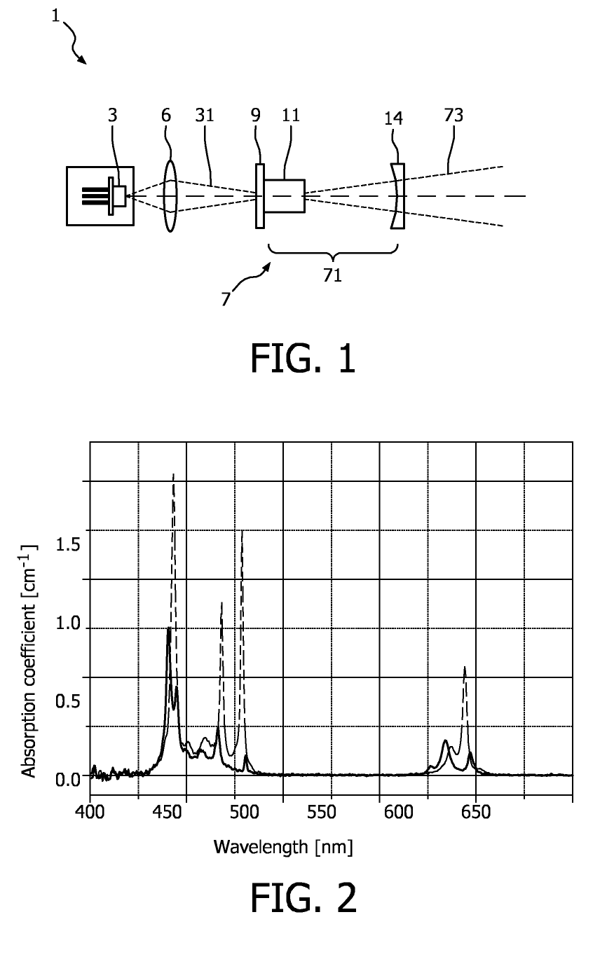

FIG. 1 shows a first embodiment of a diode pumped solid state laser device 1. The diode pumped solid state laser device 1 comprises a pump laser diode 3 and a solid state laser 7 with a laser crystal 11. According to a preferred embodiment of the invention, a blue laser diode is employed as pump light source. The solid state laser 7 is designed to emit laser light at a wavelength different from the wavelength of the laser light emitted from pump laser diode 3. For example, if a Pr:YLF crystal is used, the solid state laser can be designed to emit in the green wavelength range or in the red wavelength range.

The cavity 71 of the solid state laser 7 is terminated by a wavelength selective mirror 9, e.g., a dielectric mirror and an output coupler 14. Output coupler 14 is semi-transparent for the laser light 71 generated by solid state laser 7. For example, the output coupler can be designed to transmit a fraction of some percent of the laser radiation and to reflect the remaining radiation.

As shown in FIG. 1, the solid state laser 7 is pumped by the pump laser diode 3, by injecting the pump laser light 31 through a coupling optics or lens 6 in longitudinal direction into the laser crystal 11. For this purpose, the laser light is coupled through the wavelength selective mirror 9. Accordingly, the mirror 9 is transmissive for the pump laser light 31 but highly reflective for the laser light 73 of the solid state laser 7.

As a measure to allow for a shorter laser crystal, the output coupler 14 can reflect back the fraction of the pump laser light 31 which is longitudinally transmitted through the laser crystal. Thus, the pump laser light 31 is transmitted twice through the laser crystal 11. Preferably, the length of the laser crystal 11 with respect to its absorption of the pump laser light is chosen so that a fraction of at least 5 percent, preferably at least 20 percent of the pump laser radiation which initially enters the crystal 11 is transmitted through the crystal.

To avoid that the pump laser light 31 which has been transmitted through the laser crystal 11 mixes with the outcoupled laser light of the solid state laser, the output coupler is preferably designed as a dielectric wavelength selective mirror which is partly transmissive or semi-transparent for the solid state laser light 73, but has a high reflectivity for the pump laser light 31. A further possibility would be to insert a further dielectric mirror which reflects the pump laser light 31 but has a high transmission for the solid state laser light 71.

The second measure proposed according to the invention counteracts the problems associated with back-reflected laser radiation in the pump diode: For this purpose, it is proposed to use an anisotropic laser crystal having two different absorption coefficients for pump light polarized along a first direction transversally to the longitudinal direction of the laser crystal 11 and a second direction vertically to this first direction. This for example holds for both Pr:YLF and Pr:LiLuF₄ crystals.

The anisotropic laser crystal and the pump laser diode are mutually oriented so that the polarization of the pump laser light has a component both along the first and the second direction.

In particular, these crystals are oriented with their a and c-axis lying transversally to the longitudinal direction of the solid state laser. In this case the laser crystal 11 is oriented with respect to the pump laser diode so that the plane of polarization of the pump laser light and the c-axis of the crystal include an angle. By orienting the laser crystal not with the c-axis parallel to the pump laser polarization but at an angle, preferably between 35° and 55° (e.g. at 45°), a misalignment with respect to the orientation of maximum absorption is introduced.

The difference of the absorption coefficient for polarization parallel and orthogonal to the c-axis of Pr:YLF can be seen from FIG. 2. FIG. 2 shows the absorption coefficient of Pr:YLF as a function of the wavelength for a polarization of the pump laser light 31 parallel to the c-axis (hatched line) and perpendicular to the c-axis (continuous line). The doping level in this crystal was c_{Pr}=0.2%. As can be seen from the graphs, the intensity of the narrow absorption lines is considerably higher for polarization of the pump laser light 31 along the c-axis. The absorption line between 440 nm and 450 nm is particularly suitable for optical pumping.

However, since the absorption coefficient is different for polarization parallel and orthogonal to the c-axis, this measure changes the polarization state of the pump light and a significant part of the pump light is polarized orthogonal to the original pump light polarization after passing the laser crystal. Light polarized orthogonal to the original pump light polarization, however, does not interfere with light in the cavity of the pump laser diode 3 and therefore does not affect the pump laser diode performance.

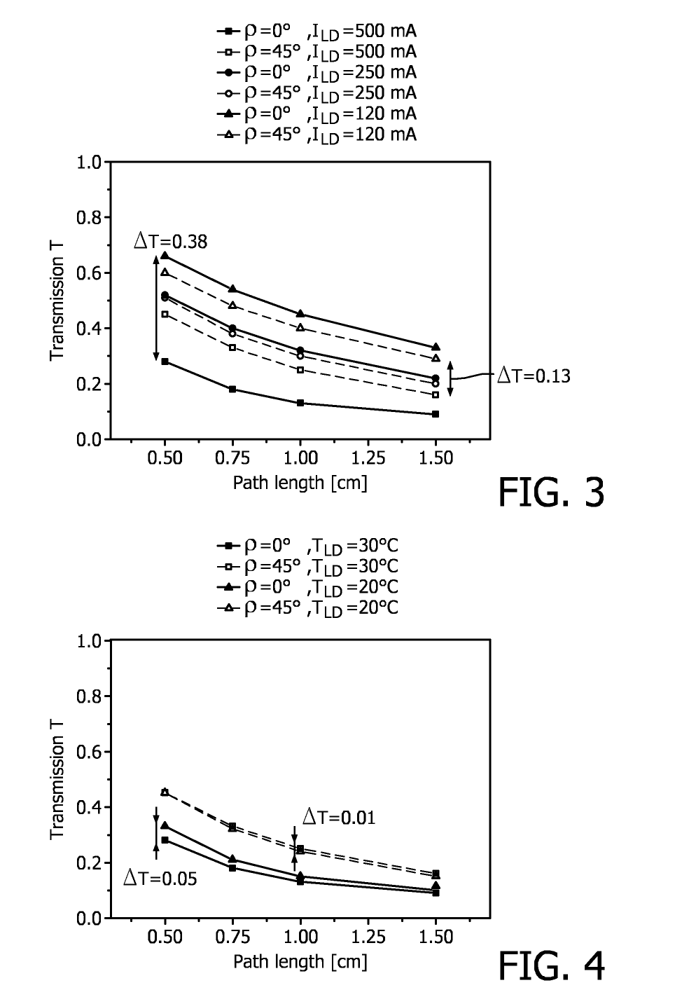

Surprisingly, in combination with backreflecting the pump light and/or just with longer crystals, this measure also helps to reduce the changes of the absorption with diode current or diode temperature variations. This fact is further illustrated by the graphs of FIGS. 3 and 4.

FIG. 3 shows graphs of the transmission of the pump laser light as a function of the path length through the laser crystal. As indicated in the legend, the graphs have been obtained for angles of 0° and 45° between the polarization plane of the pump laser light 31 and for different laser diode currents I_{LD} of 500, 250 and 120 mA. The transmission values refer to Pr:YLF crystals with 0.5% Pr-concentration.

Even though the absorption is lower (transmission higher) for the 45°-orientation, the variation with diode current is drastically reduced. While the transmission of the pump light changes from 28% for I_{LD}=500 mA to 66% for I_{LD}=120 mA for the optimum orientation of the crystal, this effect is reduced to a range of 45% to 60% for 45°-orientation.

While the difference in transmission for driving currents between 120 mA and 500 mA is up to ΔT=0.38 for the conventional parallel orientation of polarization plane and c-axis, this difference reduces to only 0.13 for the 45°-configuration according to the invention. The higher transmission for the 45°-orientation can be counteracted by longer crystals or by double-passing the crystal.

FIG. 4 shows transmissions for angles of 0° and 45° and different temperatures T_{LD} of the cavity of pump laser diode 3. The driving current was held constant at 500 mA for each graph. As can be seen from FIG. 4, the effect of different diode temperatures on the transmission or absorption of the pump light can be reduced from ΔT=0.05 down to ΔT=0.01, i.e. by a factor of 5 by rotating the crystal to 45°. Both diode current and diode temperature affect mainly the emission wavelength of the laser diode. In that sense, the measure of rotating the crystal as proposed according to the invention also increases the range of useful pump wavelengths for a diode pumped solid state laser.

A reason for the relaxed dependence on the driving current or the cavity temperature of the pump diode laser 3 appears to be the wavelength shift of the absorption line visible in the spectra of FIG. 2. If the polarization plane of the pump laser light 31 rotates, the pump laser light will eventually match the absorption wavelength so that an effective absorption occurs even if there is a slight mismatch in the crystal's absorption wavelength for polarization along the c-axis and the actual wavelength of the pump laser light 31.

Without restriction to the specific embodiments and the type of anisotropic laser crystal used, it may therefore be advantageous to provide a pump laser diode 3 which emits at a wavelength between the absorption wavelengths for polarization along the first and second directions (e.g. along the c-axis and transversally thereto).

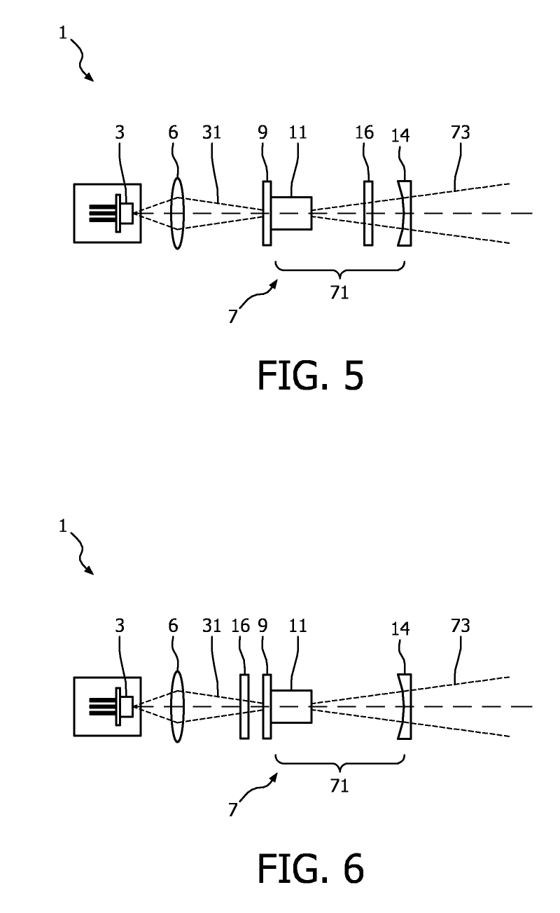

A third measure to improve the pump light absorption especially in the case of back-reflecting the pump light into the crystal 11 is the use of a quarter-wave plate 16 in the cavity 71 of solid state laser 7. Positioned with the optical axis of the quarter-wave plate 16 under an angle between 35 and 55°, in particular at an angle of 45° to the orientation of the polarization plane of pump laser diode 3, this suppresses the influence of back-reflected light on the pump laser diode 3. In this case, the polarization plane of the pump laser light 31 and the c-axis of the laser crystal 11 may also be parallel. The setup is sketched in FIG. 5. For situations where the laser crystal 11 is not oriented parallel to the laser polarization, several orientations of the quarter-wave plate are possible to reduce the amount of back-reflected light in the laser diode and to improve the pump light absorption at the same time.

The quarter-wave plate 16 can also be placed in front of the laser resonator, i.e. in front of the light entry side of the laser cavity 71, where the pump laser light 31 is injected. between the coupling optics and the wavelength selective mirror 9, as shown in FIG. 6. Placed at an angle of between 35 and 55°, in particular at an angle of 45° with respect to the pump light polarization, the quarter-wave plate 16 converts the linearly polarized pump laser light 31 into elliptically or circularly polarized light. With this setup, the orientation of the laser crystal 11 does not affect the absorption of pump laser light 31 anymore. Thus, precise alignment is not required. Pump light reflected back is then converted to linearly polarized light but orthogonal to the original pump light polarization.

Even though the exemplary embodiments described hereinbefore have been referred to bDPSSLs with Pr:YLF as the laser medium, the invention should not be limited to this case. Instead, the proposed measures are useful and applicable as well to infrared lasers, for example to diode pumped Nd:YVO₄, Nd:GdVO₄, or Tm/Ho:YLF lasers.

1. A diode pumped solid state laser device, comprising
a pump laser diode and
a laser crystal forming at least a part of a solid state laser which emits laser light at a wavelength different from the wavelength of the laser light emitted from said pump laser diode, and said solid state laser being pumped by said pump laser diode, wherein said pump laser diode is arranged to inject its pump laser light in longitudinal direction into said laser crystal, said diode pumped solid state laser device comprising at least one of
an output coupler which reflects back the fraction of said pump laser light longitudinally transmitted through said laser crystal,
an anisotropic laser crystal having two different absorption coefficients for pump light polarized along a first direction transversally to the longitudinal direction of the solid state laser and a second direction vertically to said first direction, wherein said anisotropic laser crystal and said pump laser diode are mutually oriented so that the polarization of said pump laser light has a component both along said first and said second direction, and
a retarder, said retarder converting said pump light from linearly polarized light into elliptically or circularly polarized light.

2. The diode pumped solid state laser device as claimed in claim 1, wherein said solid state laser comprises a wavelength selective mirror terminating the laser cavity of said solid state laser at the opposite end of said output coupler, wherein said light of said pump laser diode is injected through said wavelength selective mirror into said solid state laser device, said wavelength selective mirror being transmissive for said pump laser light and reflective for said laser light of said solid state laser.

3. The diode pumped solid state laser device as claimed in claim 1, wherein said laser crystal transmits a fraction of at least 5 percent of the pump laser radiation initially injected into said laser crystal, said fraction of at least 5 percent being at least partially reflected back by said output coupler.

4. The diode pumped solid state laser device as claimed in claim 1, wherein said pump laser diode is a blue emitting laser diode.

5. The diode pumped solid state laser device as claimed in claim 4, wherein said pump laser diode emits at a wavelength within the range from 435 Nanometers to 455 Nanometers.

6. The diode pumped solid state laser device as claimed in claim 1, wherein said laser crystal is a Pr:YLF crystal.

7. The diode pumped solid state laser device as claimed in claim 1, wherein said laser crystal is a Pr:LiLuF4, Pr:LiGdF₄, Pr:BaY₂F₈, or Pr:KYF₄ crystal.

8. The diode pumped solid state laser device as claimed in claim 1, wherein said output coupler comprises a wavelength selective mirror which is semi-transparent for the laser light of said solid state laser, but highly reflective for said pump laser light.

9. The diode pumped solid state laser device as claimed in claim 1, wherein said first direction of polarization of said pump laser light is the direction of polarization where said laser crystal has its maximum absorption coefficient for said pump laser light.

10. The diode pumped solid state laser device as claimed in claim 1, wherein said laser crystal has a c-axis oriented transversally to said longitudinal direction of said solid state laser, and wherein said laser crystal is oriented with respect to the pump laser diode so that the plane of polarization of the pump laser light and said c-axis of said laser crystal include an angle.

11. The diode pumped solid state laser device as claimed in claim 10, wherein said angle is between 30° and 60°.

12. The diode pumped solid state laser device as claimed in claim 1, wherein said retarder is arranged within the cavity of said solid state laser or in front of the light entry side of the laser cavity, where the pump laser light is injected.

13. The diode pumped solid state laser device as claimed in claim 1, wherein said retarder is a quarter wave-plate.

14. The diode pumped solid state laser device as claimed in claim 1, wherein the optical axis of said retarder and the polarization plane of the pump laser light include an angle of between 35 and 55°.

15. A laser image or video projection device comprising at least one diode pumped solid state laser device as claimed in claim 1.
